(19) United States
(12) Patent Application Publication
(10) Pub. No.: US 2016/0065419 A1
(43) Pub. Date: Mar. 3, 2016

(54) METHOD AND APPARATUS FOR GENERATING INSIGHT INTO THE CUSTOMER EXPERIENCE OF WEB BASED APPLICATIONS

(71) Applicant: NOKIA SOLUTIONS AND NETWORKS OY, Espoo (FI)

(72) Inventors: Peter SZILAGYI, Budapest (HU); Csaba VULKAN, Budapest (HU)

(21) Appl. No.: 14/783,252

(22) PCT Filed: Apr. 9, 2013
(86) PCT No.: PCT/EP2013/057359

§ 371 Date: Oct. 8, 2015

(51) Int. Cl. H04L 12/24; H04L 12/26; G06F 17/30

(52) U.S. Cl. CPC H04L 41/5003; G06F 17/30312; H04L 43/10

(57) ABSTRACT

Methods, apparatuses, and computer program products capable of providing insight and understanding into the user experience of web based applications are provided. One method includes collecting and measuring application level key performance indicators, detecting user actions by monitoring network side user traffic in a network, correlating the user actions with the application level key performance indicators in order to evaluate and quantify a quality of experience (Qo E) of the user, and correlating poor Qo E with network side key performance indicators in order to determine an underlying root cause of the poor Qo E.

### BACKGROUND

1. Field

Embodiments generally relate to methods and apparatuses capable of providing insight and understanding into the user experience of web based applications.

2. Description of the Related Art

Mobile device technology evolution and the increased capacity of radio access networks have created opportunity for using Internet based applications including web browsing, social networking, or watching online videos from video stores (e.g., YouTube™, Netflix™, Hulu™, etc.) on mobile phones (e.g., smartphones) or on tablets. The users of these mobile devices have the expectation of the same level of user experience as what can be achieved by connecting to the Internet via high speed low latency fixed networks. Mobile radio access technology, however, has some inherent limitations, such as the sometimes narrow last mile links, the non-uniform radio coverage and the higher intrinsic latency. Therefore, it is difficult (or expensive) to provide homogeneous service quality over the whole coverage area especially since, due to the mobility of the users, the demand is not location bound.

Internet based applications can access the content servers via data services, for example, packet data bearers over General Packet Radio Service (GPRS), Enhanced Data for GSM Evolution (EDGE), 3G, High Speed Packet Access (HSPA) or Long Term Evolution (LTE) radio access. In principle, existing systems can guarantee good service quality through their bearer centric Quality of Service (QoS) architectures that includes mechanisms such as differentiation, prioritization, packet scheduling, traffic engineering, congestion control, caching and application aware solutions; however, they are effective only when the planning and dimensioning are accurate enough, there are no configuration problems or failures in the system, the resources are not overbooked, the demand is not concentrated on a small area (e.g., in case of public events), or wherever the radio coverage is at an acceptable level.

Moreover, due to the limited number of distinct QoS classes and the different requirements of the multitude of applications, the QoS that can be offered by the network is important but not the only enabler of good Quality of Experience (QoE). In addition to good QoS level, the user experience may depend on the availability of the service, the latency of the control and signaling planes, the processing power of the network elements and factors external to the operator's network such as the Internet Round-Trip Time (RTT), the load of the content servers, the capabilities of the mobile devices, etc.

Accordingly, the operator's ability to provide seamless access to popular Internet applications and the capability to own the user experience and not to be just a bit-pipe is seen as a key differentiating factor. This requires customer experience management that consists of obtaining insight to the end user experience, detection of poor user experience, root cause analysis (diagnosis) and problem solving. Lacking the ability to detect when and where users might not be satisfied with the quality of their applications or failure to investigate the cause of the underlying problem may lead to prolonged dissatisfaction for the subscribers and eventually increased churn rate and loss of revenue for the operator.

### SUMMARY

One embodiment is directed to a method including collecting and measuring, by an application monitoring entity, application level key performance indicators. The method may further include detecting user actions by monitoring network side user traffic in a network, correlating the user actions with the application level key performance indicators in order to evaluate and quantify a QoE of the user, and correlating poor QoE with network side key performance indicators in order to determine an underlying root cause of the poor QoE.

Another embodiment is directed to an apparatus. The apparatus includes at least one processor, and at least one memory including computer program code. The at least one memory and computer program code, with the at least one processor, cause the apparatus at least to collect and measure application level key performance indicators, detect user actions by monitoring network side user traffic in a network, correlate the user actions with the application level key performance indicators in order to evaluate and quantify a QoE of the user, and correlate poor QoE with network side key performance indicators in order to determine an underlying root cause of the poor QoE.

Another embodiment is directed to an apparatus. The apparatus includes means for collecting and measuring application level key performance indicators. The apparatus may further include means for detecting user actions by monitoring network side user traffic in a network, means for correlating the user actions with the application level key performance indicators in order to evaluate and quantify a QoE of the user, and means for correlating poor QoE with network side key performance indicators in order to determine an underlying root cause of the poor QoE.

Another embodiment is directed to a computer program embodied on a computer readable medium. The computer program is configured to control a processor to perform a process. The process includes measuring application level key performance indicators, detecting user actions by monitoring network side user traffic in a network, correlating the user actions with the application level key performance indicators in order to evaluate and quantify a QoE of the user, and correlating poor QoE with network side key performance indicators in order to determine an underlying root cause of the poor QoE.

### BRIEF DESCRIPTION OF THE DRAWINGS

For proper understanding of the invention, reference should be made to the accompanying drawings, wherein:

FIG. 1 illustrates a block diagram, according to one embodiment;

FIG. 2 illustrates a block diagram depicting a workflow, according to an embodiment;

FIG. 3 illustrates a diagram depicting four modes of operation, according to one embodiment;

FIG. 4 illustrates examples of points for generating application level KPIs, according to one embodiment;

FIG. 5 illustrates an example of the DPI probe system based monitoring, according to an embodiment;

FIG. 6 illustrates an example of methods for detecting incomplete downloads, according to an embodiment;

FIG. 7 illustrates some alternatives for the IP2IMSI server implementation, according to one embodiment;

FIG. 8 illustrates a block diagram of an embodiment providing a database, according to one embodiment;

FIG. 9 illustrates a block diagram of an apparatus, according to an embodiment; and

FIG. 10 illustrates a flow diagram of a method, according to one embodiment.

### DETAILED DESCRIPTION

The system resources (e.g., transport bandwidth, air interface, hardware, processing elements) of mobile access networks are sometimes not capable of granting a satisfactory experience to every user who would like to use Interned based applications, such as web browsing, social networking (e.g., Facebook™), micro-blogging (e.g., Twitter™), or watching online videos. This may happen due, for example, to limitations in the radio access technology itself, inaccurate dimensioning and planning assumptions, non-optimal configuration, radio coverage problems, insufficient hardware capacity, limited user equipment (UE) capabilities, the mobility of the users (e.g., many active users gathering at a location may generate demand above the system capacity), etc. Also, the sheer cost of upgrading the system to be able to provide sufficient or at least better experience at some problematic location may simply be higher than the expected return of the required investment, leaving network operators disinclined to carry out such upgrades. Additionally, suboptimal or erroneous configuration of the network elements or that of the UEs or the users' subscription profile may also result in poor user experience, as well as some problems external to the operator's network (e.g., problems at the content server side).

Internet based applications generate the majority of today's mobile data traffic and they are regarded by the users as services that should be ubiquitously available anytime and anywhere they are demanded; therefore, the capability of operators to achieve high customer satisfaction regarding these applications is essential. Since, even with today's cutting edge wireless solutions, good access to these Internet based applications is not granted for each and every session the users might have, customer experience management can bring significant value to network operators. Today, network operators usually have access to reports/dashboards about network service quality measurements, such as bearer establishment success rate, handover success rate, call drops, etc., but have very limited or no insight into the user experience of popular Interned based applications.

Generating application level insight requires application level traffic monitoring and specific methods tailored to each application for quantifying the user experience, taking into account the user's actions as well (e.g., if the user has terminated the download before the requested data has been received). The analytics framework provided by embodiment herein aims at filling this gap by intercepting and monitoring the application traffic, generating application level KPIs, evaluating and quantifying the user experience and providing both high level and detailed views to the application level user experience from different angles and aggregation levels. Additionally, certain embodiments provide the means and methods of correlating the application level KPIs with the service availability related KPIs in order to enable true customer experience evaluation and root cause analysis.

In order to manage the customer experience, poor user experience needs to be detected and the cause of the problem should be localized and diagnosed. Certain embodiments of the present invention describe a framework that introduces methods and apparatuses for data collection and insight generation entirely from the network side in order to evaluate and quantify the user experience, detect QoE problems, identify and localize the affected users and provide diagnosis in a way that is not only transparent to end-users but also efficient in terms of the required computational and storage resources. By deploying the invention in a real network, it becomes possible to automatically identify problems related to online applications, e.g., localize and identify the cause of problematic (e.g., too long) web page downloads or poor video experience.

In case the operator has deployed a media adaptation functionality for web content, such as the Nokia Siemens Networks Browsing Gateway that compresses content or transcodes multimedia data (images, audio, videos, etc.) according to the UE's screen resolution or content presentation/playback capabilities (usually from high resolution towards lower resolution), it may be necessary to perform the application level measurements at a location where the adapted traffic is available since that is the content to be received by the client. In addition, for deciding if the data could be downloaded from the original content servers with sufficient quality in the first place, monitoring the application traffic both before and after the content adaptation may be required. Some embodiments can be deployed with multiple application level traffic monitoring entities at different locations in the network in order to correlate the application level measurements/KPIs; therefore, the application level quality of experience evaluation and root cause localization capabilities of certain embodiments are more accurate than what could be achieved on top of a single measurement point.

In order to evaluate the user experience of web based applications, it may not be enough to rely solely on application specific measurements that require the transmission of user data. If, for various reasons, the data transmission itself is not possible in the first place, the affected user is already unsatisfied but it would be undetectable through measurements focusing only on and deriving KPIs from the properties of application layer data transmission. If the basic network connectivity (data bearers) could be established or the UE has an already established data bearer, the actual application usage may still be prevented by failure in various supporting transport network or application layer functionality (such as failure in DNS resolution, failed connectivity to content server). Therefore, certain embodiments of the invention can be extended to evaluate the customer experience of web based applications by considering both service availability KPIs and application level KPIs.

As outlined above, one embodiment of the invention provides a method for implementing an analytics framework that is capable of providing deep insight and understanding into the user experience of web based applications, covering the entire lifecycle of application usage starting from network connectivity, bearer establishment and application usage. The framework evaluates and quantifies the customer experience, identifies and localizes users affected by poor experience and performs diagnosis to find out the root cause of the problems. The analytics framework may rely on information measured or collected during various stages of network connectivity and application usage, usually provided in the form of Key Performance Indicators (KPI). Based on their source within the end-to-end system architecture and the type of information they provide, the relevant KPIs can be classified into the following three groups: application level KPIs, service availability KPIs, or network side QoS/performance KPIs.

Application level KPIs are generated based on measurements performed on the user plane traffic after the successful setup of the data bearer service; this can include success/failure indication of the connectivity setup (e.g., DNS, TCP) between the UE and the web/content servers as well as measuring the performance and experience of the various applications during their usage and data transfer.

Service availability KPIs cover signaling procedures related to the attachment of a UE to the network including the setup of radio connectivity, the activation of a packet data protocol (PDP) context and finally establishing a data bearer that provides connectivity and data service for the UE with an external packet data network (PDN), such as the Internet. These KPIs are mostly simple binary indicators showing success/failure of a certain stage in the signaling procedures (including error causes in the failure cases).

Network side KPIs include information about radio cells or network elements (e.g., eNB/NodeB/RNC/etc.) including but not limited to load, congestion status, alarms, etc. Also, information about events such as handover, bearer QoS parameter renegotiation, etc. may be part of the network side information.

Besides the above KPIs, the framework can also detect various user actions based on the application level traffic monitoring. For example, one embodiment can detect transmission control protocol (TCP) connection terminations initiated by the user upon canceling a download in the browser. Correlating the user's actions with the measured application level KPIs is important to obtain deeper insight to the experience of the user as certain reactions (closing the connection before all content is received, terminating but restarting the connection or persistently re-requesting the same content again and again, etc.), especially when they correlate with poor experience measured via the application level KPIs, yield the plausible assumption that the user was frustrated by not being able to receive the content with sufficient quality or at all.

The framework is both application and service driven. That is, customer experience may be evaluated based on the application level performance (that requires that data service is available and the users could establish a data connection) and on the capability of the system to provide access to the service with all the required ingredients (data connection establishment with low latency, right level of QoS, seamless handovers, responsive system, etc.). The network side KPIs (both service availability and QoS/performance KPIs) and events are utilized to perform root cause analysis after problems were detected at the application/service level and the affected users were identified and localized.

Some embodiments may focus on, but are not limited to, web traffic as the majority of the Internet based applications are accessed and operated (often interactively) over the web (e.g., using the HTTP/1.1 protocol), i.e., it can be considered as a convergence layer/technology. Web traffic includes not only regular web browsing (such as reading news portals/blogs, using Facebook™, Twitter™, web-based Google Maps™, RSS feeds, etc.) but also applications downloading multimedia content over HTTP, such as YouTube™, Netflix™, Hulu™ and multimedia players presenting other audio and/or video content. Web content download requires proper operation of some of the prominent protocols of the transmission control protocol/internet protocol (TCP/IP) suite: the domain name system (DNS), the user datagram protocol (UDP), the transmission control protocol (TCP), the hypertext transfer protocol (HTTP), and even the real time streaming protocol (RTSP) for specific mobile video sessions.

One goal, according to certain embodiments, is to provide deep customer experience management according to the following approach and capabilities:
1. Identify important attributes of the application traffic and user behavior, and provide efficient methods for collecting the required information from ongoing application sessions;
2. Based on these attributes, identify and generate application level dynamic KPIs (such as the ρ and activity factor KPIs for video downloads), which enable reliable assessment of the user experience including the detection of QoE degradations;
3. Identify and localize subscribers affected by poor experience and put it in the context of network level KPIs collected from various parts of the network for root cause analysis;
4. Capture the failed attempts of the end users to establish data connections through the monitoring of the related service availability related KPIs;
5. Generate diverse aggregation levels and provide statistical analysis methods of the direct and derived KPIs;
6. Provide a validation framework to verify the usability and performance of the identified application level KPIs.

As mentioned above, ρ is one example of an application level KPI. In one embodiment, ρ may be a video-specific KPI and can be defined as the ratio of the duration of the video (i.e., the time it takes to play the video without interruption) and the download time of the video (i.e., the time it takes to download the corresponding video content). If ρ>1, it may indicate that the video content was downloaded faster than the rate at which it was played back (i.e., the media rate), meaning that there was no interruption or freezing in the playback due to lack of data since there was always some pre-buffered video content in the media player. If ρ<1, it may indicate that there were one or more periods in which the playback was frozen due, for example, to buffer under-run in the media player. This KPI can be calculated continuously at any point during the download of the video content: while the video is still being downloaded and only some part of the full video content has been sent from the server and received by the client (denoted by 0<frac<1), the duration should indicate the time it takes to play back the downloaded part only (and not the full content); therefore, the ρ can be calculated as:

$$ρ = \frac{frac \cdot duration}{download time} where frac = \frac{downloaded data}{bytelength} ,$$

and bytelength is the total size of the video data. Calculating the instantaneous (i.e., real-time) video experience only requires that the amount of video data downloaded up to a given point in time is continuously measured and accumulated during the download of the video. This can be done in a lightweight manner without decoding the video stream or looking into the content in any other way. Due to the capability of calculating the instantaneous video experience, two characteristic ρ values may be recorded for each video session to facilitate the generation of deeper insight to video experience: the smallest value of the instantaneous ρ throughout the entire download, referred to as ρₘᵢₙ, and the ρ at the end of the download, referred to as the average ρ or ρ_{avg}. Additional snapshots/sampling of ρ can of course be also recorded during the download of each video.

Correlating ρ_{avg} and ρₘᵢₙ with the user's decision (which can also be detected easily at the network side) whether to watch the entire video until it ends (complete download) or terminate it beforehand (incomplete download), the video experience can be quantified into different levels as follows, starting with the worst case:
ρ_{avg}<1 and the download was incomplete (terminated by the user): this means that the video playback was heavily affected by buffer under-runs and also the user terminated the connection eventually, probably due to dissatisfaction as the requested content was not delivered with acceptable quality;
ρ_{avg}<1 and the download was complete (fully watched by the user): this means that although the playback was frozen for some time, the user still insisted on watching the entire video after all;
ρ_{avg}>1 and ρₘᵢₙ<1 and the download was incomplete: this means that, on average, the video was downloaded with acceptable quality but there was at least one point where it was shortly frozen; however, since ρ_{avg} is above 1, the user continued watching after the problematic part (although not until the end), thus the termination of the video download was probably not due to the quality problems;
ρ_{avg}>1 and ρₘᵢₙ<1 and the download was complete: this means that the average video quality was acceptable and the user watched the entire video regardless of the problematic part.

Another example of an application level KPI is called the activity factor, which denotes the ratio of time spent with actual data transfer during the download of an online video. The activity factor can be considered complementary to ρ and can be measured for videos split into multiple parts and downloaded with hypertext transfer protocol (HTTP) progressive download, each part requiring a separate HTTP Request to be sent by the media player as discussed in the introduction. The activity factor takes a value between 0 and 1 and it is defined as the ratio of: a) the time during which actual data transfer took place between the video content server and the client browser/player; and b) the total time elapsed between the beginning and end of the video transfer. If the activity factor is close to 1 it means that there were no or only short idle periods between the download of the video data parts, i.e., the client had to request the next part as soon as the previous one has been downloaded since the download rate of the individual parts was not much (or at all) higher than the media rate. Combining the ρ and the activity factor is also possible; for instance, if an activity factor close to 1 coincides with a corresponding ρ_{avg}<1 measurement, it means that the video session was problematic throughout the entire download time and the video player could not pre-buffer enough data at any point to make postponing the next request possible. If the activity factor is well below 1 or close to 0, it reflects a download when the cumulative download rate of the individual video parts could be kept well above the media rate. The activity factor can be calculated after the video download has finished since it requires that the download time of all video parts are known; on the other hand, the activity factor is extremely lightweight since its calculation does not require knowledge of the duration of the video (and of course the video content is not parsed/decoded at all).

According to certain embodiments, the application level KPIs can be measured in any core network element that has access to plain user traffic. Obtaining the service availability and network side KPIs is possible from the network management system (NMS), such as Nokia Siemens Networks NetAct and traffic analysis tools such as Nokia Siemens Networks Traffica. The NMS (e.g, NetAct) is able to provide information on a network element's radio/transport related configuration as well as status information (e.g., list of enabled/active features), topology information that may help in problem localization, radio connectivity/PDP activation/bearer setup/handover failure statistics, etc. The task of the traffic analysis tool (e.g., Traffica) is to collect, store and serve (to various network analytics and reporting tools) information on traffic volume and application usage distribution corresponding to different aggregation levels (from an individual user up to aggregated cell/eNB/RNC/etc. throughput) and different time granularity (e.g., aggregating measurements and presenting statistics in an hourly resolution). Some network side QoS and performance KPIs are also directly measured and stored by the traffic analysis tool, such as cell radio load, transport load, bearer establishment success ratio, handover statistics, etc.; some of these may also be available from the NMS. The traffic analysis tool is also capable of providing real time reporting of various events, such as data bearer establishment, modification or deactivation.

An alternative or additional source of information can be provided by means of probes attached to a user plane or control plane interface (such as the LTE SGi, S1-U or S1-MME). Particularly, deep packet information (DPI) probes are not only able to look into the protocol headers but also to drill down to the level of user TCP/IP, HTTP and application data (provided that the content is not encrypted). Therefore, DPI probes are suitable for performing detailed application level measurements and thus generate application KPIs as well. In probe systems, multiple probes may be deployed in the same network on different interfaces. This can provide multiple measurement points of the same event in the network, which allows the tracking of user activity from the bearer setup to the user plane traffic and also allows the following of the control plane signaling message flow. Therefore, a DPI probe system is able to directly provide both application level and service availability KPIs.

It should be noted that certain embodiments may apply to any fixed or mobile system that offers Internet connectivity to the users, as embodiments introduce a method for customer experience assessment through a set of dynamic KPIs that can be used efficiently regardless of the access technology (e.g., xDSL, WiFi, WiMAX, GPRS, EDGE, HSPA, HSPA+, LTE and beyond).

As outlined above, certain embodiments provide an analytics framework that is capable of providing important insight into the user experience of web based applications. Certain embodiments are configured to evaluate and quantify the user experience based on monitoring the user behavior/actions, the application level KPIs, and, optionally, the service availability KPIs. Embodiments can then detect QoE degradations and investigate the root cause of the problems by identifying and localizing the affected subscribers and correlating their poor experience with network side KPIs.

One embodiment is directed to a method of user experience evaluation that may include measuring application level KPIs and detecting user actions, for example, by means of lightweight network side user traffic monitoring. The method may then correlate the user actions with the application level KPIs in order to evaluate and quantify the user experience, and correlate poor user experience with network side KPIs in order to find out the underlying root cause. The method may also link problems detected at the application level to subscriber identity (IMSI) and location to provide insight for operator services, such as customer care, marketing departments, as well as network dimensioning and optimization activities. Thus, one embodiment provides this method of user experience evaluation (based on the application KPIs, the detected user actions and optionally on the service availability KPIs), poor QoE detection, user identification, localization and root cause analysis (based on correlating application level, service availability and network side KPIs).

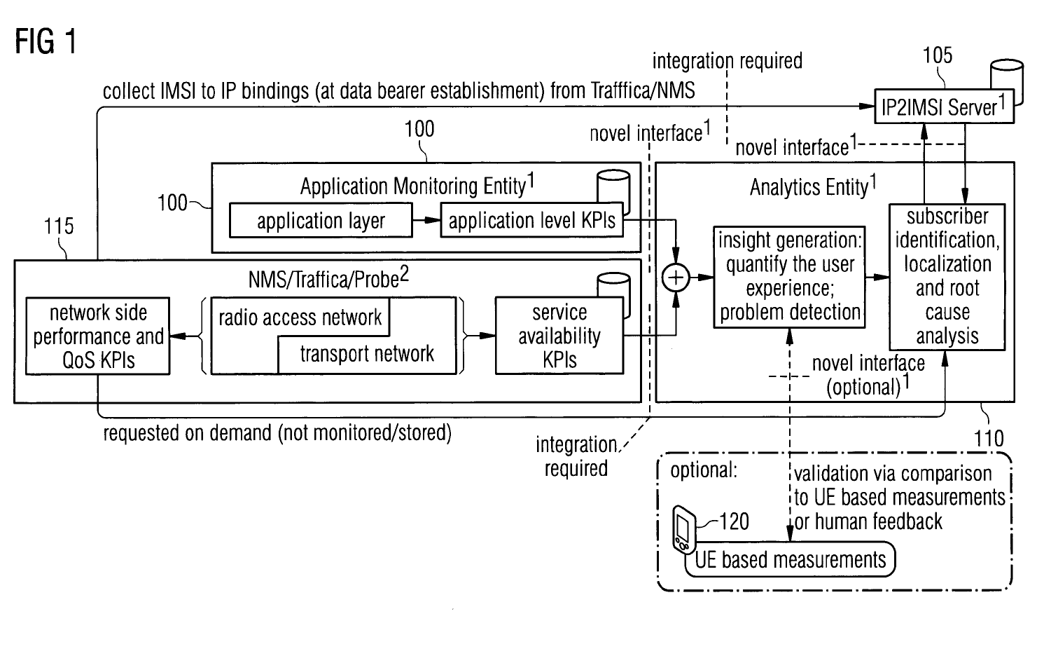

FIG. 1 illustrates an example of a block diagram of the framework, according to one embodiment. The core framework according to this example includes three entities: the Application Monitoring Entity (AME) 100, the IP2IMSI Server 105 and the Analytics Entity (AE) 110, which are connected to each other and also to additional network side data sources, such as the NMS, probes or traffic monitoring systems 115, depending on the actual implementation. Therefore, interfacing with these tools and between the AME 100, the IP2IMSI Server 105 and the AE 110 is an integral part of the solution provided by certain embodiments.

In one embodiment, the AME 100 collects application level KPIs and detects the corresponding actions of the user 120 by intercepting and monitoring the user plane traffic at some point in the network. Therefore, the AME 100 can provide information that reflects both the application quality and the user behavior under good or poor service conditions. Suitable locations for the AME 100 include, but are not limited to, the operator's wireless application protocol (WAP)/Internet gateway (GW), such as the Nokia Siemens Networks Browsing GW or the Nokia Siemens Networks Flexi gateway platform; network monitoring and management tools, such as Traffica; a standalone HTTP proxy server within the operator's premises that is configured in the subscribers' browsers so that web traffic is accessed via the proxy; a Radio Network Controller (RNC) in 3G/HSPA systems; an Evolved Node B (eNB) in LTE systems; DPI probe system based interception; or a standalone network element sniffing the user plane traffic without terminating any of the protocol layers.

The AME 100 has access to the unencrypted user plane web traffic to enable accessing the protocol headers, and, occasionally, the downloaded content to generate the application level KPIs, which are either sent (pushed) to the AE 110 or made available for querying via a database interface. If a web content adaptation mechanism is applied to web traffic in the network (such as the one implemented in the NSN Browsing GW), monitoring the application traffic at multiple locations may be required (i.e., both before and after the content adaptation) in order to perform measurements on the traffic that is actually received by the client and also for being able to decide if the data is received from the original content servers with sufficient quality (in time, enough throughput, etc.) in the first place.

According to an embodiment, the AE 110 generates insight to the customer experience based on the application level KPIs and corresponding user actions received from the AME 100. From this information, application sessions initiated after a successful data bearer establishment can be evaluated. Those sessions that could not even start due to earlier failures during the radio access or bearer establishment connectivity procedures may not be detected and evaluated at this point, but such failures are usually already collected and presented to the network operator by other means (e.g., via dashboards). However, for proper customer experience assessment, the AE 110 collects the related KPIs from the network management system. In addition, by measuring application KPIs in multiple AME 100 instances at different locations (e.g., in case of content adaptation) or separately corresponding to the external network (such as the round-trip time between the AME 100 and the Internet-based content servers) and to the operator's network (such as network side connection establishment latency or RTT, DNS or TCP failures, etc.), the basic localization of the problem is also possible. For example, this localization may be done by checking whether the set of problematic KPIs correspond to server side measurements or to the operator's network, thus separating server side and network side problems.

This application driven approach is lightweight as it only requires data generated by the AME 100, with no real-time correlation with data sources from other parts of the network, such as the service availability or network side KPIs. Also, the generation of the application level KPIs in the AME 100 are scalable as they do not require capturing the intercepted application data for offline analysis or perform computationally expensive and non-scalable tasks such as decoding the video streams. Therefore, embodiments are much lighter than already existing and deployed network side solutions such as a HTTP proxy with content adaptation (e.g., the NSN Browsing GW), which not only relays the HTTP messages but also has to transcode multimedia content according to the UE capabilities. The application level quality of experience evaluation can already provide great added value to operators by detecting problems that otherwise (e.g., via monitoring conventional KPIs such as bearer setup/handover success rates or call drops) would not be uncovered at all.

The lightweight application driven approach outlined above can be flexibly extended by adding the service availability KPIs into the scope of the user experience evaluation as not being able to start an application due to, for example, a coverage hole or a bearer establishment/PDP context activation failure that already negatively impacts the user experience. This requires that the service availability KPIs (including unsuccessful radio access attempts, bearer setup failures, handover failures, etc.) are obtained from the NMS, from traffic monitoring systems, or from probes deployed on signaling interfaces (such as the S1-MME in LTE), depending on the implementation. The collection of the service availability KPIs and their correlation with the application level KPIs may require a heavier apparatus compared to the lightweight application driven approach, as both types of KPIs need to be collected from different sources and evaluated jointly by the AE 110.

Based on the correlation of application level KPIs and the user actions (and, if collected, including also the service availability KPIs), the AE 110 can evaluate and quantify the current QoE in different aggregation levels (in a given cell/eNB/RNC/TA/etc., focusing on a single user, a set of users or all users, considering different time intervals, etc.). Analyzing the trend of the user experience is possible by validating the QoE against operator-set thresholds, performing day-on-day or week-on-week trend analysis, identifying persistent problems, the most affected subscribers, or using any other evaluation method that combines and correlates the user experience with the location of the user, the network status, the user behavior during poor service or any other contextual information.

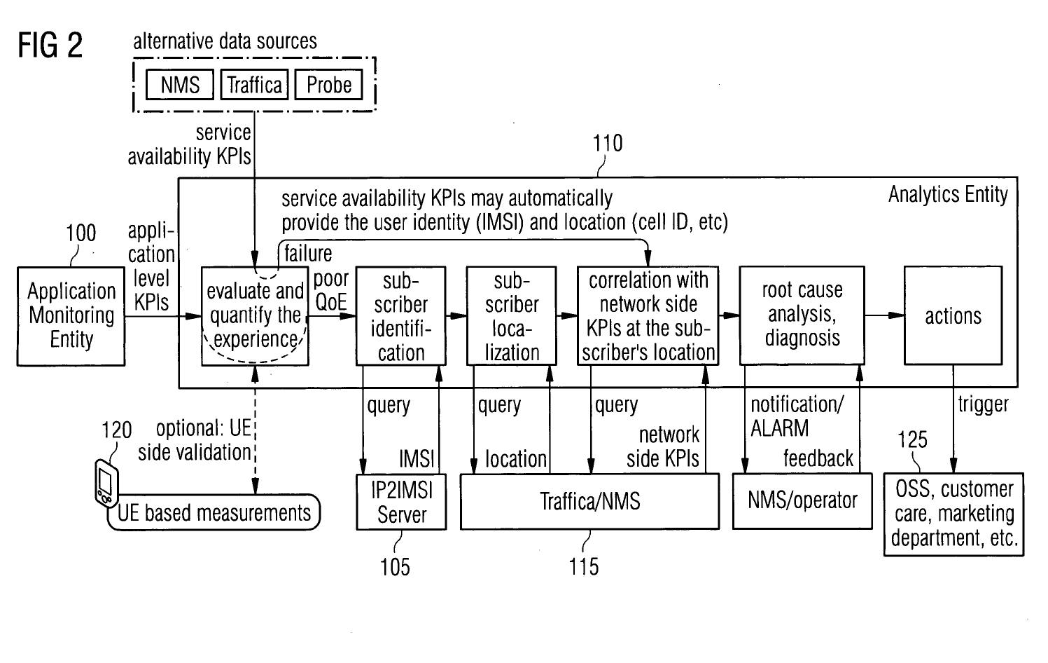

FIG. 2 illustrates a block diagram depicting the workflow of the analytics framework, according to one embodiment. In an embodiment, the identification of the subscribers affected by poor quality of experience may be required for certain operations. For instance, the identification of affected subscribers may be needed in order to link poor quality of experience detected at the application level (KPIs and user actions) with the permanent identity of the subscribers, for example the international mobile subscription identifier (IMSI); this may be required since the only user identity that is automatically available from the traffic itself is the UE's dynamically generated mobile IP address, which is unique to the user only at a given time and may be reallocated later to another user's UE. In addition, the identification of affected subscribers may be needed to accurately localize the user or the network area where the poor performance was experienced (i.e., obtain the cell, BTS, etc. where the user was connecting to the network during the poor experience). Further, the identification of affected subscribers may be used to correlate the user experience derived from application level KPIs and user actions with the service availability KPIs.

In order to associate the application level KPIs with the permanent user identity, the temporary IP address may be mapped to the subscriber's IMSI. This mapping of the temporary IP address to the IMSI can be performed by the IP2IMSI server 105 based on the IP to IMSI bindings performed by the network during data bearer activations. These bindings are collected either from the NMS 115 (e.g., Traffica) via its round trip time (RTT) export functionality or interfacing directly with one of the network elements, such as the gateway general packet radio system support node (GGSN)/packet gateway (PGW)/mobility management entity (MME), over the RADIUS protocol. Based on the IMSI, the NMS 115 can be queried for the identity of the cell/eNB/BTS/RNC/etc. where the subscriber was located at the time when the poor experience was detected. As a result, the user can be localized. Since the service availability KPIs are derived from signaling messages during radio network side connection establishments, bearer management or mobility events (handovers), etc., they already contain the IMSI of the subscriber directly as well as the accurate location information (indicating the radio cell and/or the network elements where the problem has occurred).

Given the location of the user, additional network side KPIs required for root cause analysis can be queried from the NMS 115 corresponding to the user's location only. Thus, the amount of data that is transferred is much less and more focused than a solution which would require constant monitoring of the network side KPIs. For performance and scalability reasons, it may be important that sporadic, non-persistent user experience problems do not immediately trigger root cause analysis, saving the cost of collecting, storing and analyzing the network side KPIs. Accordingly, a single problematic web page or online video download may not trigger immediate root cause analysis unless these problems become significant, persistent or recurring at a given location, above target or related to subscribers being important to the operator (e.g., very important persons, high revenue generators, or those with an extended social network and high influence in real life).

Automated actions, such as reconfiguration, may also be triggered in case the framework is integrated with the Operations Support System (OSS) 125. Additionally, valuable information can be provided to the operator's customer care to be able to better handle incoming user complaints (e.g., by having more accurate information on general level known problems or why a user in particular may be unsatisfied); the marketing department can check the quality of a recently introduced (and heavily marketed) service, etc.; valued subscribers with detected problems can also trigger automatic notification or warning. Another use case can be to trigger a troubleshooting process in certain problematic cases either by notifying the appropriate operation personnel or triggering automatic or semi-automatic workflows.

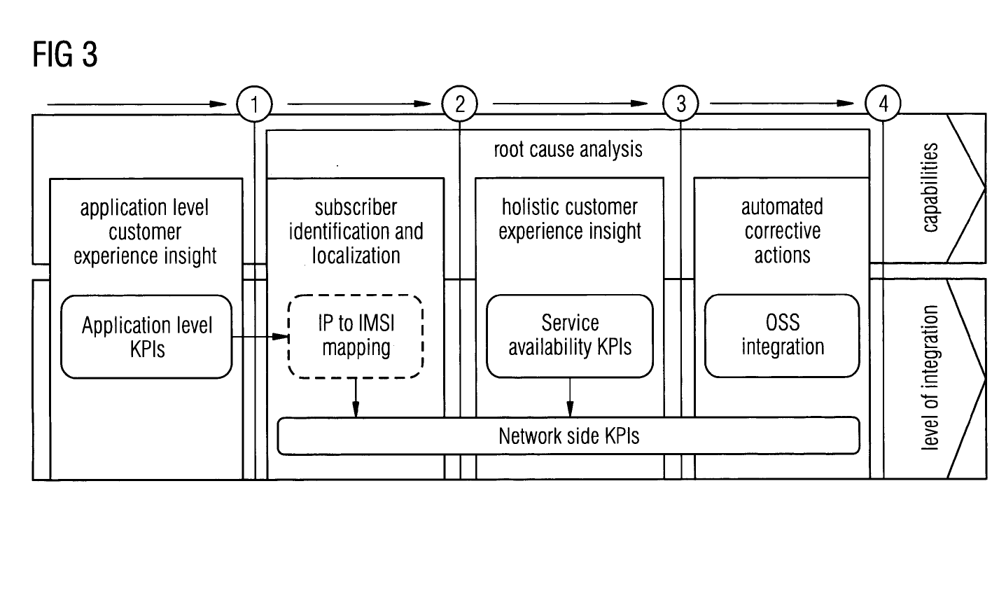

Based, for example, on the type and amount of required information, the supported use cases and the capabilities of the analytics framework, it can be configured according to at least four modes of operation, as illustrated in the example of FIG. 3:

1. Lightweight application level customer experience insight:
This mode can provide standalone application level customer experience evaluation with basic diagnostic capabilities (e.g., separating server/network side problems). Within this mode, the AE 110 is able to provide insight to application sessions starting after successful data bearer establishment.

2. Implementation of subscriber identification and localization:
The mapping of the IP addresses to the IMSI can be implemented in order to link the application level QoE with the true subscriber identities and for localization. This also facilitates querying network side KPIs that are specific to the user's location when poor user experience is detected at the application level, which may be required for root cause analysis.

3. Holistic insight generation with the addition of service level KPIs:
In addition to the application level KPIs, collecting the service availability KPIs may be needed for a holistic customer experience evaluation that covers the experience from the radio attach through bearer establishment to the application usage. This mode enables advanced analytics techniques that operate on a merged database of service availability and application level KPIs, e.g., it is possible to detect if the user experience was good on the application level but was preceded by unsuccessful network connectivity or bearer establishment attempts, which indicate that despite the good application level experience, the user may have been still unsatisfied with that particular application session.

4. Additional automated actions:
The possible corrective actions, notification of the operator's customer care or marketing departments, triggering of troubleshooting workflows and their implementation depend on the actual OSS environment and, thus, may require customization and (possibly proprietary) system integration.

The customer experience evaluation and quantification provided by the AME 100 can be verified by a user based feedback mechanism, for example comparing the QoE calculated by the framework with the opinion of human testers. If there is a difference in evaluating the user experience between the AE 110 and the users' feedback, the KPI generation and/or the quantification of the user experience can be updated or refined to better match the opinion of the users. Alternatively or additionally, a UE based monitoring application or plug-in can also be deployed to selected handsets to directly monitor application level events and measure KPIs (such as video playback freezing, web page download times, etc.) and compare it to the application level KPIs calculated by the AME 100 at the network side; this does not validate the user experience directly but verifies that the application level KPIs measured at the network side accurately reflect the events at the UE side.

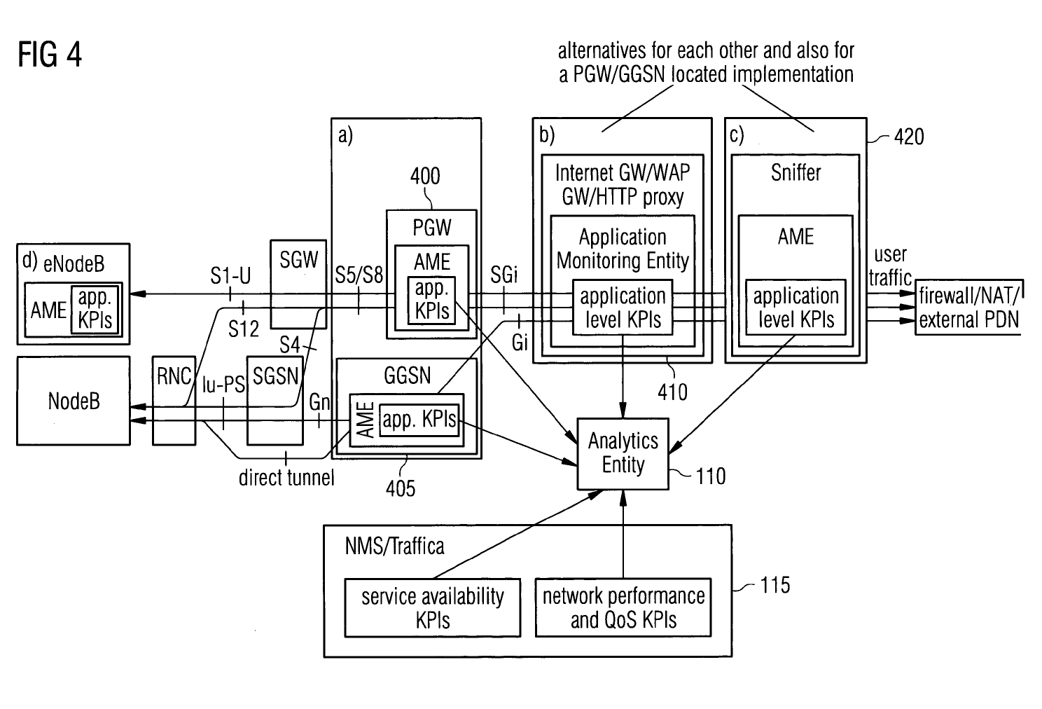

In one embodiment, the generation of application level KPIs and the detection of the user's actions at the AME 100 may be facilitated by intercepting/monitoring the user plane data flow during the application activity. This can be implemented in various ways. FIG. 4 illustrates some examples of possible points for generating application level KPIs in the AME 100. In the example of FIG. 4, four alternative locations may be used as the interception point where the AME 100 can be integrated to generate the application level KPIs. For instance, AME 100 may be integrated in: (a) core network elements, such as the PGW 400 (in LTE) or in the GGSN 405 (in 3G/HSPA/HSPA+systems); (b) Internet GW/WAP GW/HTTP Proxy 410; and/or (c) standalone sniffer 420; (d) in a radio access network element such as a Radio Network Controller (RNC) or an Evolved Node B (eNB). According to an embodiment, the standalone sniffer node 420 does not terminate any of the protocol layers (as opposed to the HTTP proxy, which terminates the TCP connections). The proxy based implementation may be preferable in the situation where the proxy performs web content adaptation, since in that case the original and the adapted content are both available in the same network element.

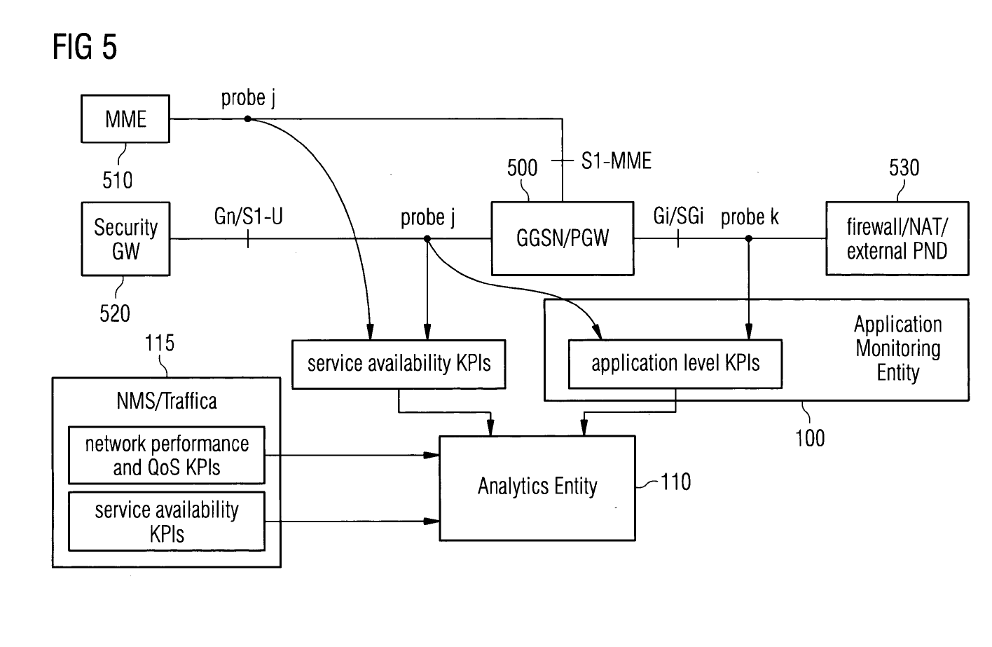

An alternative to the network element based implementation of the AME 100 discussed above in connection with FIG. 4 is deep packet inspection (DPI) probe system based monitoring. FIG. 5 illustrates an example of the DPI probe system based monitoring, which includes attaching DPI probes to various network interfaces where the user plane data flow is available, such as the Gn/Gi interfaces in 3G/HSPA/HSPA+systems or the S1-U/SGi interfaces in LTE systems. As illustrated in the example of FIG. 5, a probe i may be attached on the interface between MME 510 and GGSN/PGW 500, a probe j may be attached on the interface between security GW 520 and GGSN/PGW 500, and probe k may be attached on the interface between GGSN/PGW 500 and firewall/NAT/external PDN 530. In one embodiment, access to the unencrypted user data may be required, which means that the probes may be deployed on interfaces where the plain user plane data flow is accessible (e.g., before the security gateway in downlink if there is such network element).

By monitoring the application traffic, the AME 100 is able to measure and generate application level KPIs; these include connectivity problems related to DNS or TCP, measuring the latency of the DNS name resolution or establishing the TCP connections, measuring the TCP RTT and its variation, the HTTP RTT, the download time of HTTP objects as well as accessing any information that is available from the DNS, IP, TCP and HTTP protocol headers, such as the content type or size of the HTTP objects. Through monitoring the TCP data segments sent to the client and the TCP acknowledgments (ACKs) sent back by the client, it is possible to follow the amount of data that the client has received without error (i.e., the number of acknowledged bytes). Also, by monitoring the advertised window size reported by the client TCP receiver, it can be detected if the client side application does not consume the data although it was delivered by the network in time or the application could have still received more data. These measurements can be utilized by the AE 110 in order to decide if the client itself was limiting the achievable user experience (e.g., by not being able to process the received data) or if it was the network (or the content server) not delivering the data at the rate that would have been required for a good user experience.

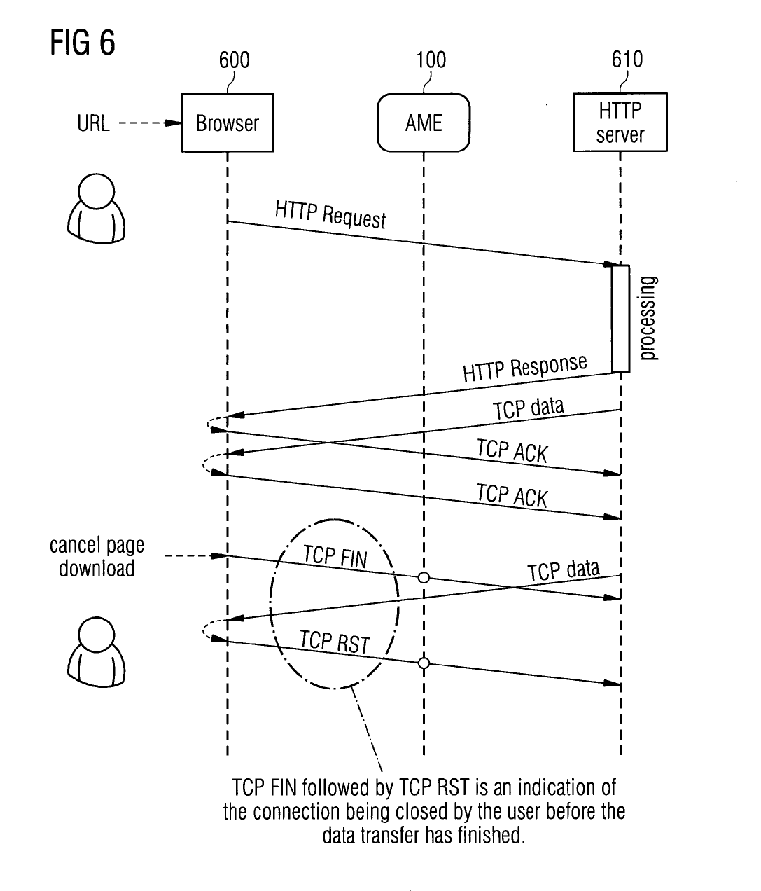

According to an embodiment, the AME 100 is also able to directly detect the type or category of the downloaded content (based on which its importance can be identified and used during the user experience evaluation) and it can also detect certain user actions and convey this information to the AE 110 along with the application level KPIs. Incomplete downloads due to user termination can be detected in at least two ways, both of which can be implemented to make the detection more robust. FIG. 6 illustrates an example of the methods for detecting that a user has interrupted the download of an HTTP object, according to one embodiment. The first method is to measure the number of bytes received after the HTTP response header, which is sent from the HTTP server 610 to the browser 600, in the same TCP connection and check if the content-length field matches the measured data. If the measured data is less than the amount indicated in the content-length field and the user has closed the connection (i.e., sent the TCP finish (FIN) first), it is an indication of a download interrupted by the user. An additional method is to look for the TCP finish (FIN) and subsequent TCP segments with reset (RST) flags set by the client; the RST flags indicate that the client has abruptly closed the TCP connection without receiving all data sent by the server.

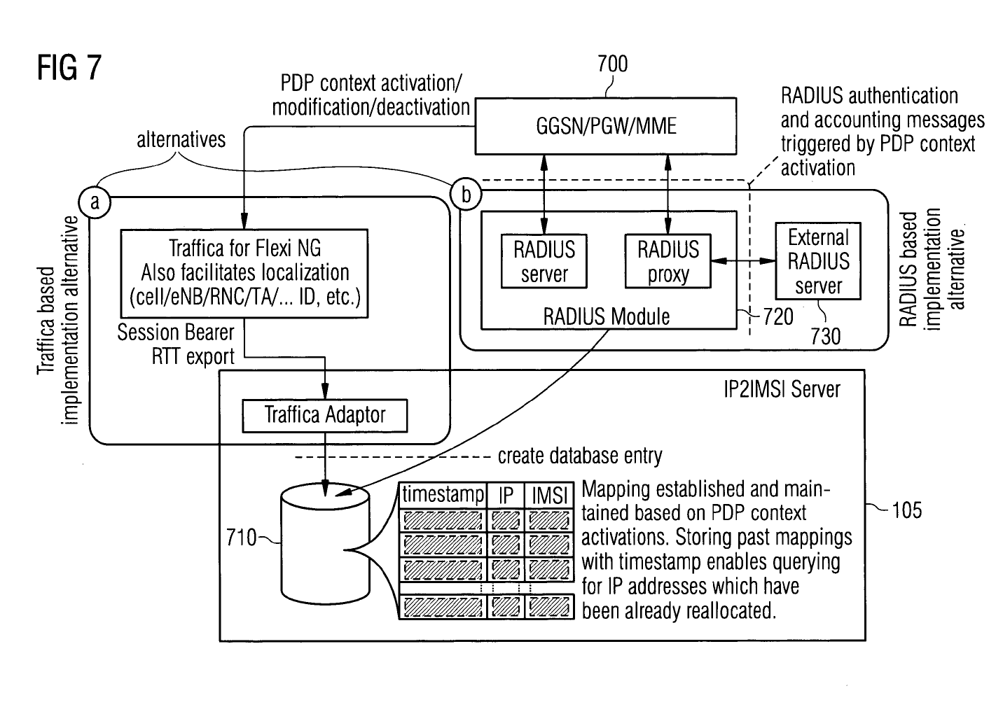

Application level KPIs and user actions measured/detected by the AME 100 may be identified by the dynamic IP address of the UE. However, as discussed above, subscriber identification, problem localization and root cause analysis may all require that the temporary IP address is mapped to the permanent IMSI. FIG. 7 illustrates two alternatives for the IP2IMSI server 105 implementation. In the example of FIG. 7, the IP2IMSI server 105 may be implemented: (a) on top of the traffic analysis tool (e.g., Traffica for Flexi NG); or (b) by connecting to the GGSN/PGW/MME 700 over the RADIUS protocol.

The traffic analysis tool (e.g., Traffica) based implementation can make use of the information included in the session bearer RTT reports generated by the traffic analysis tool whenever a data bearer (e.g., PDP context) is activated, modified, or deactivated. One such report contains a set of parameters including bearer and subscriber identities, network element identities and QoS parameters; most importantly, the dynamic IPv4/IPv6 address allocated to the UE and the permanent IMSI of the subscriber are both contained in session bearer RTT reports in case the report was triggered by data bearer creation (i.e., PDP context activation). The IP2IMSI server 105 may collect these reports through the RTT export mechanism (e.g., receiving the data over FTP) via a functionality referred to as the Traffica Adaptor, for example in FIG. 7, which extracts the IP address and the IMSI from the reports and stores them in a database 710 along with the timestamp of the bearer creation event (carried in the Fng_Bearer_Bearer_Creation_Date/Time fields of the Session Bearer RTT report). In an embodiment, the database 710 is owned by the IP2IMSI server 105, which implements a query interface for looking up the IMSI based on an IP address and a timestamp and returns the IMSI to which the supplied IP address was bound at the given time. Storing the timestamp in the database along with the IP to IMSI mapping enables correctly resolving IP addresses corresponding to, for example, older measurements or application level KPIs even if the IP address has been already reallocated to another UE.

An alternative to the traffic analysis tool (e.g., Traffica) based implementation is to connect to the GGSN/PGW 700 or directly to the MME over the RADIUS protocol and retrieve the subscriber identifiers (international mobile subscription identifier (IMSI), international mobile equipment identifier (IMEI), mobile station international subscriber directory number (MSISDN)) based on the dynamic IP address of the UE. In this embodiment, as illustrated in FIG. 7, an entity referred to as the RADIUS module 720 is provided and is able to operate either as a RADIUS server or as a RADIUS proxy. In RADIUS server mode, the module 720 receives RADIUS authentication and accounting messages from the GGSN/PGW/MME 700, extracts subscriber identifiers, creates a valid RADIUS response and returns it to the GGSN/PGW/MME 700. In RADIUS proxy mode, the received RADIUS messages are forwarded between the GGSN/PGW/MME 700 and an external RADIUS server 730. In any case, the obtained IP and IMSI identities are reported to the IP2IMSI server 105 to be stored in the mapping database along with the timestamp of receiving the first RADIUS message.

An advantage of the traffic analysis tool (e.g., Traffica) based identification is not only that the user identity can be extracted from the session bearer RTT reports but also the localization of the user is directly provided via the following fields of the same report (shown in parentheses):
the cell ID (Fng_Bearer_Cell_Id for 2G/GPRS and Fng_Bearer_eCell_Id for LTE);
the LAC/RAC/SAC/TAC (Fng_Bearer_LAC/RAC/SAC/TAC);
the eNB identity (Fng_Bearer_eNodeB_IP_Address for LTE);
the MME identity (Fng_Bearer_MME_IP_Address for LTE);
the PGW/SGSN identity
   (Fng_Bearer_PDN_GW_GGSN_Control/User_Plane_IP_Address);
the SGW identity (Fng_Bearer_Serving_GW_Access_User_Plane_IP_Address for LTE);
the radio access technology (Fng_Bearer_Radio_Access_Technology).

Using the RADIUS based implementation of the subscriber identification, the localization step may need to be done by an additional method, possibly via the NMS. On the other hand, the RADIUS based implementation does not require that the traffic analysis tool (e.g., Traffica) is deployed in the operator's network.

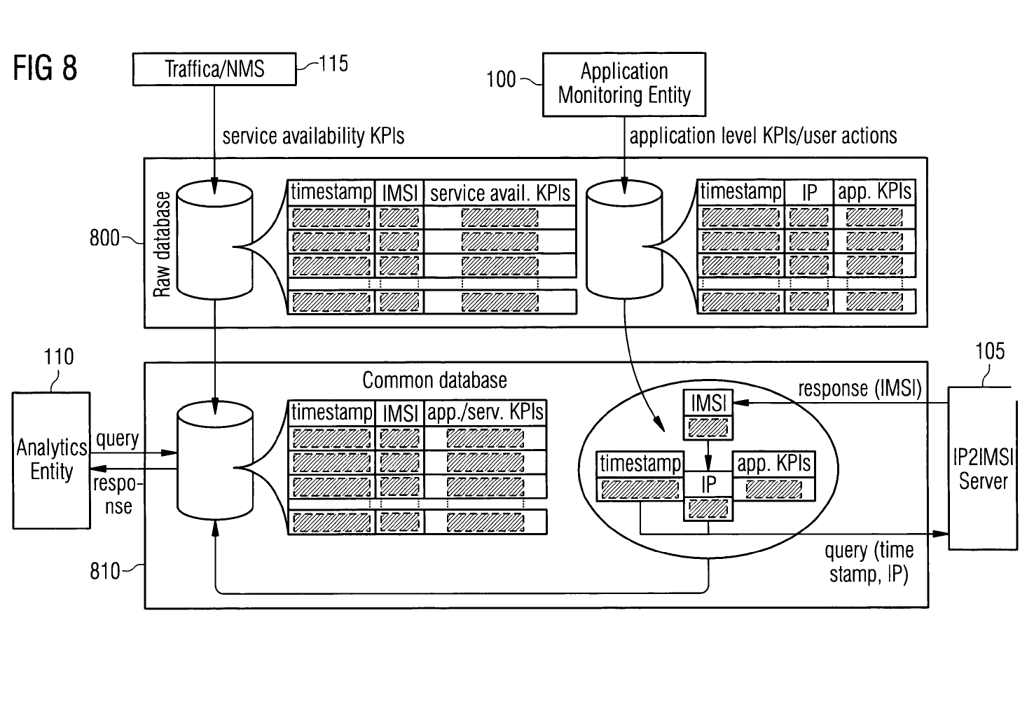

FIG. 8 illustrates a block diagram of an embodiment for creating a common database 810 with IMSI key for service availability and application level KPIs. According to one embodiment, the application level KPIs and user actions generated by the AME 100 can be collected in a database, which can be queried by the AE 110 to perform the analytics process. The database can have different stages, such as an initial raw database 800 indexed by the temporary IP address of the UE, and a consolidated database, which is a transformation of the raw database by means of mapping the IP to IMSI through the IP2IMSI server 105. In order to provide true user experience evaluation, besides the application level KPIs and user actions, certain embodiments can also collect the service availability KPIs related to network attach, bearer establishment, mobility, etc. Certain embodiments can even create a common database 810 for storing both service availability KPIs collected from the traffic analysis tool (e.g., Traffica) and application level KPIs generated by the AME 100, as illustrated in FIG. 8. The IP key of the application level KPIs is mapped to the IMSI key based on queries from the IP2IMSI server 105 before transferring to the common database 810, whereas service availability KPIs already having the IMSI key can be transferred without change. Data transferred from the separate raw databases 800 to the common database 810 can be deleted from the corresponding separate database.

Alternatively, in certain embodiments, the service availability KPIs can even be initially collected in the common database 810, eliminating the need for the temporary raw database 800; however, in this embodiment, high performance may only be ensured when the common database 810 is hosted at a node that is close to the network element at which the service availability KPIs are generated (e.g., the corresponding Traffica Network Element Server).

Based on the specific type of deployment, the AE 110 queries the database containing the application level KPIs and user actions or, in the case where the service availability KPIs are also collected, the AE 110 can directly query the common database 810. When there is a failure indication during the network connectivity phase (radio attach, bearer setup failure, etc.) captured by the service availability KPIs, it is regarded as a poor user experience by definition irrespective of the specific application the user wanted to use (which cannot be known), as it was not possible for the user to start using the application at all. Similarly, connectivity failures at the application level (DNS lookup failure, TCP connection problem, etc.) available from the application level KPIs can also be regarded as equally poor user experience, both when they occur at an early stage of the connectivity procedures so as to prevent the application usage or when they occur later during the actual usage of the application. If the application could be successfully started and data is transferred, the AE 110 quantifies the user experience based on correlating the user's actions and the application level KPIs (measured by the AME 100), such as the ρ and the activity factor KPIs for video downloads, the latency of DNS lookups, the latency of TCP connection establishments, client side and server side HTTP RTTs, download time of HTTP objects, etc.

By correlating the user's actions with the application quality of experience, different customer experience categories can be defined. For example, the worst category may correspond to experiencing obvious failures either during the network connectivity phase (bearer setup) or later during the application usage (DNS, TCP, HTTP), detectable directly from the service availability and application level KPIs. On the other hand, the best category may correspond to successful connectivity (both bearer setup and application level) and good experience measured by the application level KPIs. In between the worst and best category, i.e., in the rest of the (non-trivial) cases, different additional categories can be created based on the granularity of the experience provided by the application level KPIs and the user's actions. Generally, the same quality of experience (i.e., same application KPIs) should be considered worse in case the user's actions indicate frustrated behavior. Such user actions may include the termination of the connection before the requested data was downloaded, repeatedly re-requesting the same content over and over again, terminating and re-establishing the network connectivity (bearer), etc.

The user experience evaluation may also consider the usual quality to which a given subscriber is accustomed. In other words, it can be checked if the experience of a user has degraded compared to its own history. It is plausible that such cases make the user unsatisfied due to the psychological effect of the direction (i.e., decreasing) of the quality change, even if the customer experience category corresponding to the decreased quality would not be considered specifically poor. In fact, there can be other users whose accustomed quality is not as great and, therefore, for these users the same experience would not be considered relatively poor at all. For benchmark purposes, the best quality of experience measured for a given user and/or at a given location and/or at a given time of day, etc. can be stored to assess the maximum achievable quality the system can provide. It should be noted that user specific benchmarks can also incorporate the terminal limitations, whereas system-wide benchmarks do not exhibit this bias due to the diversity of the mobile devices.

The impact of poor user experience or the quantification of the user experience in the first place can be detailed further by classifying the application/content the user has used/requested. Various classes can be identified, such as: content or application simply used for leisure activities or killing time (e.g., online music, Last.fm, etc.); applications used regularly but not being vital (such as Facebook™, Twitter™, etc.); and important services which, when requested, must be available immediately and with no errors otherwise they almost inevitably cause serious frustration (such as online maps, timetables of planes/trains, governmental pages, medical or educational institutes, web shops, etc.). The category of most of the content or applications can be easily identified by the AME 100 based on the content server name, which is included in the URL of the web page (e.g., “maps.google.com” for Google Maps, “*.facebook.*” or “*.fb.*” for Facebook™, etc.). Building a list of matching patterns (wildcard, regular expression, etc.) for each category enables the fast classification of the content or application. Also, in certain embodiments, it may be used only where the experience was not good to reduce processing. However, building per-user statistics about the visited content types and the corresponding experience is also possible and can be a valuable insight for churn prediction as users with increasingly poor experience with important applications or content are more likely to switch operators.

The poor quality of application experience and user actions that indicate being unsatisfied/frustrated are correlated with network side KPIs (after the affected users are localized) in order to find the root cause. As discussed above, the network side KPIs can provide information on the system's operation such as the radio load of the cells, the congestion status of transport nodes, handover problems, hardware load/status, ALARMs, etc. The most plausible root cause(s) behind poor user experience can be suggested by the framework in different ways. For example, when the poor QoE coincides with a clear indication of a network side bizarre state (e.g., very high load, congestion, known HW/radio coverage limitation, etc.), a handover problem affecting the user, bearer QoS renegotiation, limited capabilities of the UE, etc., it is probably the cause of the QoE problems. Also, by recording the root causes during manual/semi-manual troubleshooting sessions as well as the corresponding KPIs that were checked by the decision making process to come to the diagnosis, certain embodiments can later match the current state of the same KPIs against these recorded patterns to suggest the root causes found at similar cases diagnosed previously.

According to an embodiment, the AE 110 can also check if the UE capabilities enable seamless application usage in the first place. For example, if the IMEI identifies a device with low processing power and narrow achievable bandwidth due to limited coding and modulation capabilities, trying to watch a YouTube™ video in high definition would be problematic due to the device itself. In order to find out if the UE device is the bottleneck, certain embodiments monitor the UE's feedback collected by the AME 100 on different protocol layers, such as the rate of the TCP ACKs, the TCP advertised window size, etc. Based on these measurements, the AE 110 can detect whether the client application (e.g., the YouTube™ plug-in or application) was not able to read the downloaded data from the TCP receive buffer thus the application itself was the bottleneck (indicated by a decreasing or eventually zero advertised window size in the TCP ACKs sent by the client). If the UE limitation is clearly indicated, certain embodiments can even skip the more costly collection and correlation of other network side KPIs as the diagnosis is the UE limitation itself. For cross-validation, such findings can be checked against the IMEI of the device as if it indicates a powerful new model UE, the symptoms of the UE limitation are either measurement errors (probable if only happens rarely and not correlates with a given subscriber) or may even indicate device misconfiguration if it is detected frequently for a given user.

The UE side limitation may not only originate from the device itself but also from its firmware, the operating system (OS), or the specific browser type and version used to access the web. Checking the known limitations, issues or bugs of the specific firmware, OS, browser, etc. during the evaluation of the customer experience provides contextual information that can be utilized both for assessing the user experience itself and for finding the cause of poor experience, such as when the specific version of the browser run by the user is known to have rendering issues or known for not being able to play the type of YouTube™ video (such as Flash/HTML5) requested by the user. Detecting the OS/browser type and version is possible by interpreting the HTTP user-agent field of the HTTP request messages sent by the client application whereas the firmware version is part of the IMEI number. The known limitations of the firmware, browsers and operating systems can be collected both from web/press publications such as technology reviews or benchmark test results (applicable only to the newest and/or most popular models) and via statistical evaluation by collecting the device/OS/browser types and configurations that can be most frequently associated with poor quality application sessions.

Besides the UE capabilities, the device configuration and also the subscription profile of the user can be checked as these can also limit the achievable quality of experience (e.g., certain subscription packages put a constraint on the achievable bandwidth). Additionally, even if the subscription allowed the required quality of service that enables good user experience, the network may not be able to establish the data bearers with the required QoS settings (e.g., due to temporary overload, etc.). Deciding if the cause for the poor user experience was one of the above problems, the AE 110 may check the QoS parameters of the data bearer in which the application data was transferred (available as part of the service availability KPIs) and also may check the subscription profile of a user by interfacing with the home location register (HLR)/home subscriber server (HSS) using one of the RADIUS/Diameter protocols or using lightweight directory access protocol (LDAP) queries in case of a One-NDS based HSS implementation. Feedback from the operator about the quality of the diagnosis can be taken into account to refine the root cause analysis.

Most current methods existing for user experience evaluation produce an overall score or index (e.g., mean opinion score), which is based on the combination and aggregation of several input parameters, usually by individually evaluating certain QoS measurements on a uniform scale (e.g., from 1 to 5) and calculating their weighted average (with weights defined by an analytic or experimentally calibrated model) as the overall score or applying logarithmic or negative exponential formulas on one or more QoS input parameters (such as the download time of web pages, number or duration of stalling events during a video playback, etc.). One problem with such evaluation is that once the score or index has been calculated, it carries no indication of how and why the specific value of the score was given and what were the elements which contributed to that value; therefore, it is also not possible to drill down and analyze what are the most common components based on which the evaluation resulted in poor experience either generally or in a given specific case. This at the same time also makes the root cause analysis more complex as the score does not give any hint about the possible location of the problem. Also, such evaluation is rigid as it is applied uniformly to all user sessions and does not take into account the usual experience to which a given user has been accustomed or the experience of others using the network at the same time, the capabilities of the end device, the type of the requested content, etc.

While the embodiments described herein may also make use of metrics similar to scores when it is meaningful (e.g., by correlating the ρ with the user's actions, it is possible to generate a score for videos), these are only characterizing the experience from a specific aspect and they are only contributors to the evaluation of the user experience, which also takes into account many more additional aspects, such as all of the application level KPIs, the content type, the own experience of the user to which they are accustomed, the experience of other users at the same time, network benchmarks, UE capabilities, etc. All of these are available for evaluating the experience and also for the root cause analysis as they are not aggregated into a single score. Therefore, certain embodiments are able to drill down and analyze why a given session was evaluated as poor, identify the most frequent problems for a user, an application or within a given customer experience category (which would not be possible if only the high-level classification was available). On the other hand, the user (i.e., the network operator) does not have to be presented with all these details in order to have an overview of the user experience in the network as embodiments are able to generate insight to user experience at different aggregation levels starting at the highest level (e.g., all traffic going through the same GW), which can then be narrowed down to specific users, subscription categories, applications, location, network elements, cells, etc. However, it is also important that the aggregation should not hide problems that are expressive at one of the lower levels but only correspond to a small share (and thus might be invisible) within the overall traffic, for instance if 99% of the sessions were evaluated as having good experience but the rest 1% all comes from the same few cells it may indicate a local problem. In order to capture these cases but still not overload the operator with details, the most problematic applications, users, network elements, etc. can be collected at each aggregation level and presented as a dashboard.

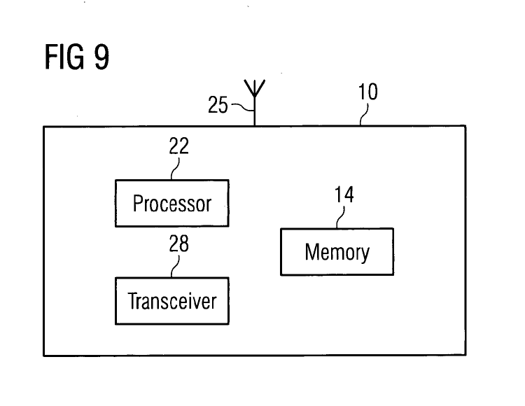

FIG. 9 illustrates an example of an apparatus 10 according to an embodiment. It should be noted that one of ordinary skill in the art would understand that apparatus 10 may include components or features not shown in FIG. 9. Only those components or feature necessary for illustration of the invention are depicted in FIG. 9. In one embodiment, apparatus 10 may be a network element. For example, apparatus 10 may be implemented as an AME 100 and/or AE 110, as discussed above.

As illustrated in FIG. 9, apparatus 10 includes a processor 22 for processing information and executing instructions or operations. Processor 22 may be any type of general or specific purpose processor. While a single processor 22 is shown in FIG. 9, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 further includes a memory 14, which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas 25 for transmitting and receiving signals and/or data to and from apparatus 10. Apparatus 10 may further include a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In an embodiment, apparatus 10 may be controlled, by memory 14 and processor 22, to measure and/or generate application level KPIs and to detect user actions, for example, by monitoring network side user traffic. Apparatus 10 may then be controlled, by memory 14 and processor 22, to correlate the user actions with the application level KPIs in order to evaluate and quantify QoE for a user of an application. Apparatus 10 may further be controlled, by memory 14 and processor 22, to correlate poor QoE for the user with network side KPIs in order to determine an underlying root cause for the poor QoE. In an embodiment, apparatus 10 is controlled, by memory 14 and processor 22, to link the poor QoE detected at the application level to a subscriber identity and location to, for example, provide insight to the operator. According to one embodiment, apparatus 10 may be further controlled, by memory 14 and processor 22, to correlate the QoE derived from the application level KPIs and the user actions with service availability KPIs.

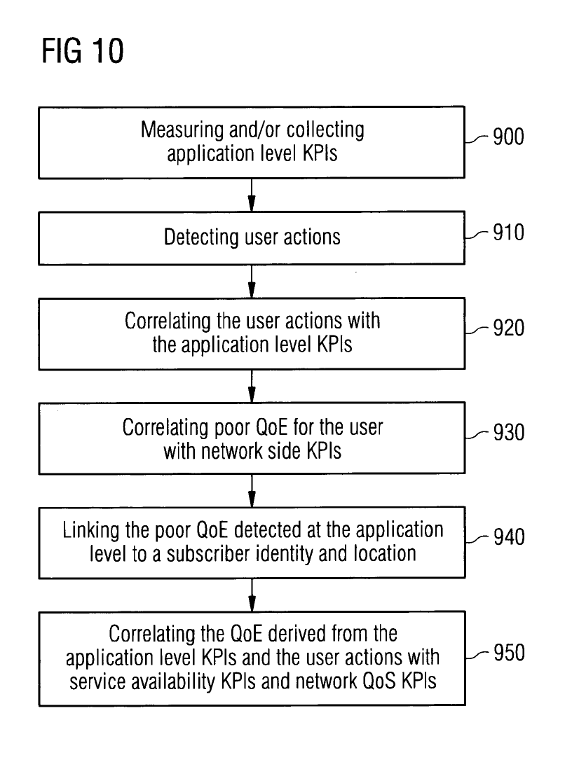

FIG. 10 illustrates an example of a flow diagram for a method of measuring and providing insight into a user's quality of experience in using applications. The method may include, at 900, measuring and/or generating application level KPIs, for example, by monitoring network side user traffic. The method may also include, at 910, detecting user actions and, at 920, correlating the user actions with the application level KPIs in order to evaluate and quantify QoE for a user of an application. The method may further include, at 930, correlating poor QoE for the user with network side KPIs in order to determine an underlying root cause for the poor QoE. The method may also include, at 940, linking the poor QoE detected at the application level to a subscriber identity and location thereby providing insight to the operator regarding the user's QoE and underlying causes for the poor QoE. According to one embodiment, the method may further include, at 950, correlating the QoE derived from the application level KPIs and the user actions with service availability KPIs and network QoS KPIs.

In some embodiments, the functionality of any of the methods described herein, may be implemented by a software stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1.-29. (canceled)

30. A method, comprising:
collecting and measuring, by an application monitoring entity, application level key performance indicators;
detecting user actions by monitoring network side user traffic in a network;
correlating the user actions with the application level key performance indicators in order to evaluate and quantify a quality of experience (QoE) of the user; and
correlating poor QoE with network side key performance indicators in order to determine an underlying root cause of the poor QoE.

31. The method according to claim 30, further comprising linking the poor QoE detected at the application level to a subscriber identity and location to provide insight to an operator of the network.

32. The method according to claim 30, further comprising correlating the QoE derived from the application level key performance indicators and the user actions with service availability key performance indicators.

33. The method according to claim 30, wherein the detecting further comprises intercepting and monitoring user data plane flow during application activity.

34. The method according to claim 30, wherein the collecting and the detecting further comprise attaching deep packet inspection probes to network interfaces where the user data plane flow is available.

35. The method according to claim 30, wherein the linking further comprises mapping a temporary internet protocol (IP) address of the user's user equipment (UE) to an international mobile subscription identifier (IMSI) based on IP to IMSI bindings performed by the network during data bearer establishment, wherein the bindings are collected from a network management system or form a core network element over RADIUS protocol.

36. The method according to claim 30, wherein the collecting and measuring further comprises detecting connectivity problems related to domain name system (DNS) or transmission control protocol (TCP), measuring latency of the DNS name resolution or establishing the TCP connections, measuring the TCP round trip time (RTT) and the hypertext transfer protocol (HTTP) RTT, the download time of HTTP objects, and accessing any information that is available from the DNS, IP, TCP and HTTP protocol headers.

37. The method according to claim 30, wherein the detecting of the user actions further comprises detecting a type or category of content downloaded by the user, wherein the detecting of the type or category of the content downloaded comprises detecting whether the content downloaded is incomplete.

38. The method according to claim 30, further comprising storing the collected application level key performance indicators, the detected user actions, and/or the service availability key performance indicators in a database.

39. The method according to claim 30, further comprising defining a plurality of customer experience categories according to the correlating of the user actions to the application level key performance indicators.

40. The method according to claim 39, wherein one of the plurality of customer experience categories is a worst category corresponding to obvious failures during network connectivity phase or during application usage, wherein the obvious failures are detectable directly from the service availability key performance indicators and the application level key performance indicators.

41. The method according to claim 39, wherein one of the plurality of customer experience categories is a best category corresponding to successful connectivity and good QoE during application usage as measured by the application level key performance indicators.

42. An apparatus, comprising:
at least one processor; and
at least one memory comprising computer program code,
the at least one memory and the computer program code configured, with the at least one processor, to cause the apparatus at least to
collect and measure application level key performance indicators;
detect user actions by monitoring network side user traffic in a network;
correlate the user actions with the application level key performance indicators in order to evaluate and quantify a quality of experience (QoE) of the user; and
correlate poor QoE with network side key performance indicators in order to determine an underlying root cause of the poor QoE.

43. The apparatus according to claim 42, wherein the apparatus comprises an application monitoring entity implemented in at least one of core network elements, Internet gateway/wireless application protocol gateway/hypertext transfer protocol proxy, radio access network element, or a sniffer node.

44. The apparatus according to claim 42, wherein the at least one memory and the computer program code are further configured, with the at least one processor, to cause the apparatus to attach deep packet inspection probes to network interfaces where the user data plane flow is available.

45. The apparatus according to claim 42, wherein the at least one memory and the computer program code are configured, with the at least one processor, to cause the apparatus to link the poor QoE to the subscriber identity and location by mapping a temporary internet protocol (IP) address of the user's user equipment (UE) to an international mobile subscription identifier (IMSI) based on IP to IMSI bindings performed by the network during data bearer establishment, wherein the bindings are collected from a network management system or form a core network element over RADIUS protocol.

46. The apparatus according to claim 42, wherein the at least one memory and the computer program code are further configured, with the at least one processor, to cause the apparatus to detect connectivity problems related to domain name system (DNS) or transmission control protocol (TCP), measure latency of the DNS name resolution or establish the TCP connections, measure the TCP round trip time (RTT) and the hypertext transfer protocol (HTTP) RTT, the download time of HTTP objects, and access any information that is available from the DNS, IP, TCP and HTTP protocol headers.

47. The apparatus according to claim 42, wherein the at least one memory and the computer program code are further configured, with the at least one processor, to cause the apparatus to detect a type or category of content downloaded by the user, wherein the detecting of the type or category of the content downloaded comprises detecting whether the content downloaded is incomplete.

48. The apparatus according to claim 42, wherein the at least one memory and the computer program code are further configured, with the at least one processor, to cause the apparatus to store the collected application level key performance indicators, the detected user actions, and/or the service availability key performance indicators in a database.

49. A computer program, embodied on a computer readable medium, wherein the computer program is configured to control a processor to perform a process, comprising:
collecting and measuring application level key performance indicators;
detecting user actions by monitoring network side user traffic in a network;
correlating the user actions with the application level key performance indicators in order to evaluate and quantify a quality of experience (QoE) of the user; and
correlating poor QoE with network side key performance indicators in order to determine an underlying root cause of the poor QoE.
